(19) United States
(12) Patent Application Publication
(10) Pub. No.: US 2004/0075225 A1
(43) Pub. Date: Apr. 22, 2004

(54) Collet inserts and methods for making the same

(76) Inventor: Guido Heim, Lake Vills, IL (US)

Correspondence Address: GROSSMAN & FLIGHT LLC, Suite 4220, 20 North Wacker Drive, Chicago, IL, 60606-6357, US

(21) Appl. No.: 10/685,857

(22) Filed: Oct. 15, 2003

Related U.S. Application Data
(60) Provisional application No. 60/418,624, filed on Oct. 15, 2002.

(51) Int. Cl. B23Q 3/12

(52) U.S. Cl. 279/9.1; 279/43; 279/143

(57) ABSTRACT

A collet insert fabricated from planar material is disclosed. The collet insert may include a substantially cylindrical sleeve, a shoulder adjacent the sleeve and a gripping portion adjacent the shoulder. In such an arrangement, the sleeve, the shoulder and the gripping portion may include a longitudinal seam. Additionally or alternatively, the inner diameter of the sleeve may be smaller than the inner diameter of the shoulder.

### RELATED APPLICATION

This application claims the benefit of U.S. Provisional Patent Application Serial No. 60/418,624, filed on Oct. 15, 2002.

### TECHNICAL FIELD

The present disclosure pertains to collets and, more particularly, to spring collet inserts and methods of making the same.

### BACKGROUND

Collets are used in many applications in which a power tool needs to grip a piece of stock material or to grip a tool, such as, for example, a router bit. Collets include a spindle having a hollowed out portion and a threaded outer periphery. The spindle is rotably powered by an electric motor or any other rotational machine. A spring collet insert (“collet insert”) is placed within the hollow portion of the spindle and a collet nut, or chuck nut, having an aperture is loosely screwed onto the threaded outer periphery of the spindle. The collet insert has a through hole and also includes a tapered outer periphery, or shoulder, that mates with a tapered inner periphery of the spindle and protrudes from the spindle. The collet insert also includes a number of axial slots that enable the inner diameter of the through hole to shrink when pressure is applied to the outside of the collet insert.

The tool or stock is inserted through the aperture of the collet nut and into the collet insert. The collet nut is then tightened onto the threaded spindle periphery. As the collet nut is tightened onto the spindle, the collet nut forces the collet insert into the spindle and the tapered outer periphery of the collet insert into engagement with the tapered inner periphery of the spindle, thereby causing the diameter of the through hole in the collet insert to shrink as the collet nut is tightened. The tool or material stock is thereby gripped by the reduced diameter of the collet insert. As will be readily appreciated, collets can accommodate small variations in the diameter of the material or tool to be chucked. Different size collets that are still smaller in diameter than the hollow portion of the spindle accommodate different diameters of tools or stock.

Traditional collet inserts are fabricated from solid portions of base material, such as aluminum or steel. The base material is machined using a lathe until the outer diameter of the base material is proper and the shoulder on the base metal is formed. The through hole of the collet insert is then made by a drilling or boring process and the slots are cut to allow the diameter of the collet insert through hole to be reduced when the collet nut is tightened. Machining collet inserts is a time consuming and expensive process.

### BRIEF DESCRIPTION OF THE DRAWINGS

FIG. 1 is an assembly diagram of an example collet.

FIG. 2 is a side elevational view of the collet insert of FIG. 1.

FIG. 3 is an end elevational view of the collet insert of FIGS. 1 and 2.

FIG. 4 is a cross-sectional view of the collet insert taken generally along lines 4-4 of FIG. 3.

FIGS. 5A and 5B collectively form an example diagram of a strip having a collet insert in various stages of fabrication.

### DETAILED DESCRIPTION

As described below, a collet insert may be fabricated from flat sheet metal according to a stamping process. The transformation of the substantially planar sheet metal into a collet insert may be accomplished by, for example, the use of a progressive die that forms and shapes the sheet metal in various stages into the final collet insert shape.

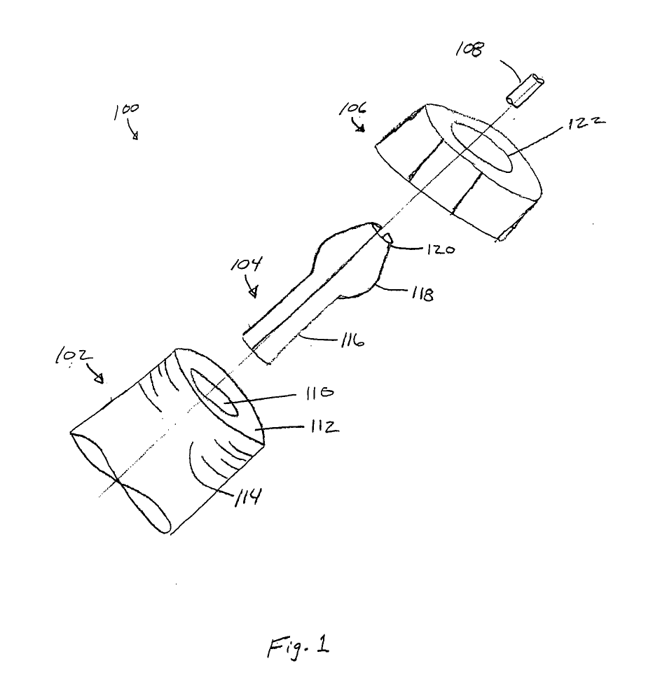

Turning now to FIG. 1, an example collet 100 is shown. The collet 100 generally includes a spindle 102, a collet insert 104 and a collet nut 106. The spindle 102 may form a portion of a power tool, such as a router or the like. Also shown in FIG. 1 is a member 108, which may be a tool shaft such as a router bit or a portion of stock material that may be gripped by the collet 100. The member 108 is shown merely for purposes of description, is part of an example environment of use and does not form a portion of the collet 100.

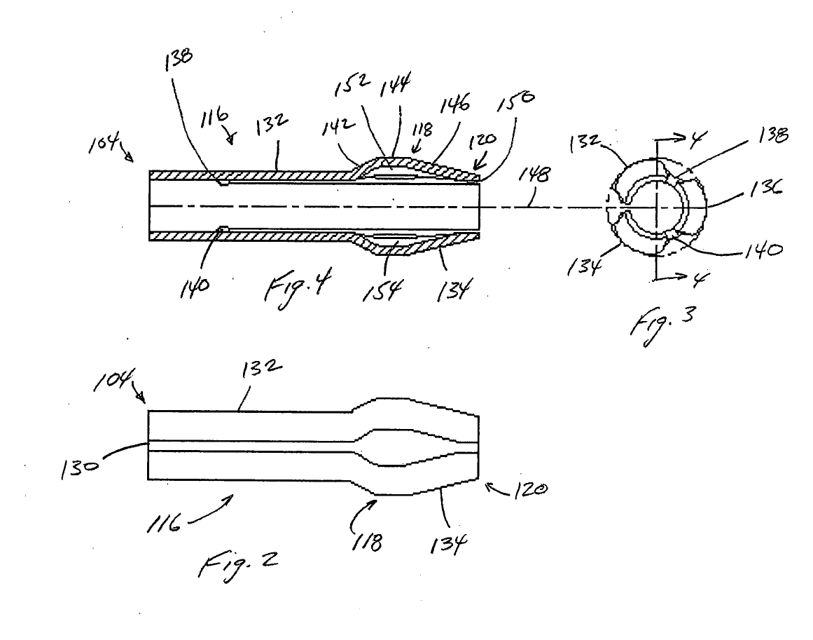

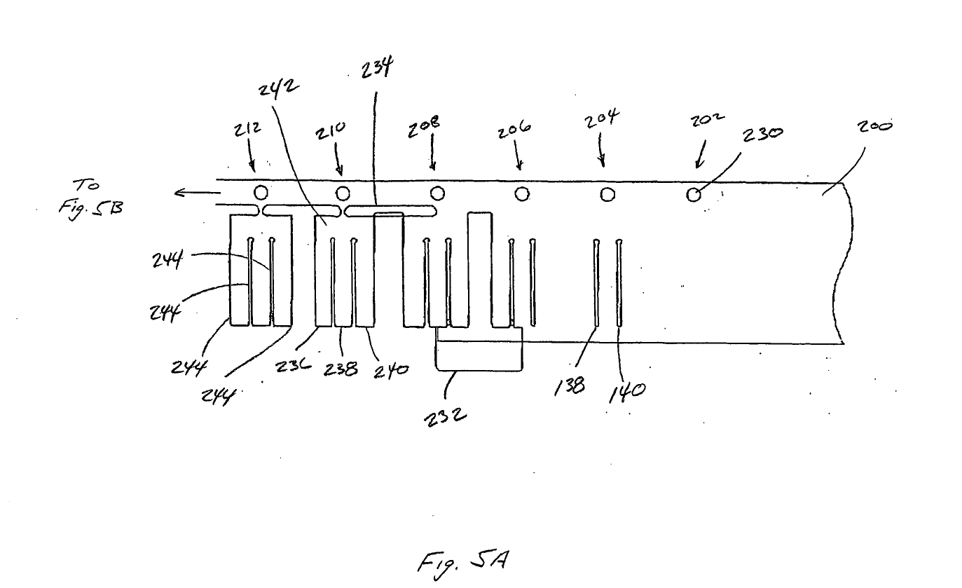

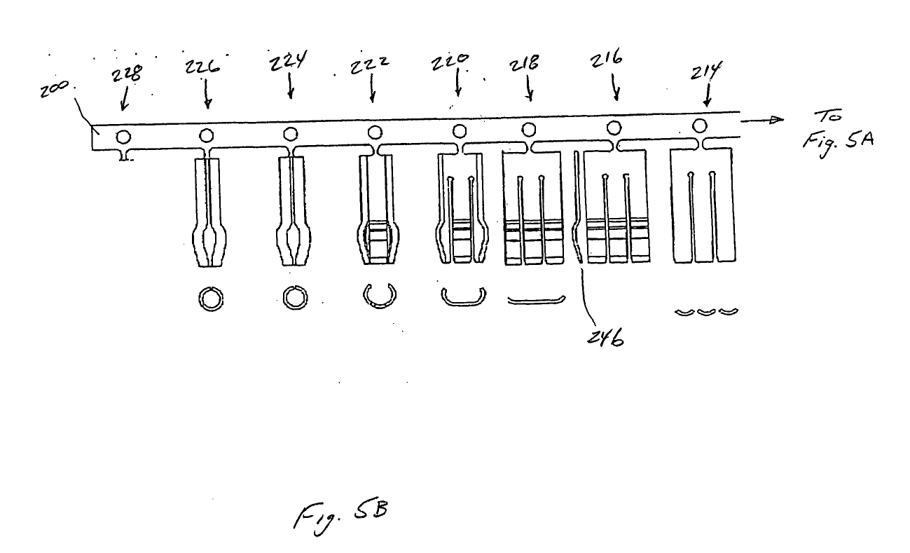

The spindle 102 includes a bore 110, a tapered inner periphery 112 and a threaded outer periphery 114. The collet insert 104 includes a sleeve portion 116, a shoulder 118 and a gripping portion 120. Further detail pertinent to the collet insert 104 is provided below in conjunction with FIGS. 2-4 and detail pertinent to the manufacture of the collet insert 104 is provided in conjunction with FIG. 5.

In operation, the collet insert 104 is placed into the bore 110 of the spindle 102 until the shoulder 118 of the collet insert 104 abuts the tapered inner periphery 112 of the spindle 102. The collet nut 106 is then threaded onto the spindle 102. Owing to an aperture 122 in the collet nut 106, the gripping portion 120 of the collet insert 104 is visible when the collet nut 106 has been threaded onto the spindle 102. So long as the collet nut 106 is not tightly threaded onto the spindle 102, the diameter of the gripping portion remains large enough to accommodate the member 108. Accordingly, when the collet nut 106 is loose, the member 108 may be inserted through the aperture 122, past the gripping portion 120 and into the sleeve portion 116 and the bore 110.

After the member 108 has been inserted into the collet insert 104 and the spindle 102, the collet nut 106 is tightened onto the spindle 102 in order to secure the member 108 in the collet insert 104. As the collet nut 106 is tightened, the collet nut 106 engages the collet insert 104 and urges the shoulder 118 of the collet insert 104 against the tapered inner periphery 112 of the spindle 102, thereby causing the diameter of the gripping portion 120 to reduce and to grip the member 108. When the shoulder 118 presses against the tapered inner periphery 112 of the spindle 102, the slot 130 allows the diameter of the sleeve 116 to be fitted snugly around the member 108. When a member is tightened into the collet insert 104, the true indicator runout (TIR) of the member is preferably a maximum of 0.015 inches.

The portion 146 is angled to be slightly steeper at the collet insert 104 than the slope within the collet nut 106. This relationship ensures ample tightening pressure at the gripping portion 120 of the collet insert 104.

To remove the member 108 from the collet 100, the collet nut 106 is loosened from the spindle 102, which causes the shoulder 118 to be less forcefully urged against the tapered inner periphery 112 of the spindle 102 and causes the gripping portion 120 to relax its tension on the member 108. The collet insert 104 is fabricated from resilient material, such as, for example, spring steel. Accordingly, when the collet nut 106 is loosened, the collet insert 104 substantially returns to its original position, thereby enabling the member 108 to be removed therefrom. Once the gripping portion 120 is relaxed, the member 108 may be extracted from the collet insert 104 and, in turn, from the spindle 102.

FIGS. 2-4 show further detail of the collet insert 104 of FIG. 1. The collet insert 104 includes a seam 130, which may be a closed seam or an open seam. An open seam may have a width of, for example, 0.5 mm. A closed seam may, for example, include abutting flat edges of material or may, for example, include edges of material that are designed to interleave with one another in a tongue and groove manner. Because the collet insert 104 is fabricated from sheet metal as explained below, the collet insert 104 includes a seam.

The collet insert 104 also includes three flutes 132-136 defined by the seam 130 and first and second slots 138 and 140, which are also roughly 0.5 mm in width. Each of the flutes 132-136 includes sections that form a part of the sleeve portion 116, the shoulder 118 and the gripping portion 120.

For purposes of explanation, the detail of the flute 132 is provided, it being understood that the remaining flutes 134 and 136 are identical or substantially identical to the flute 132. While the following provides example dimensions of the collet insert 104, it should be understood that such dimensions are for purposes of explanation and that other dimensions could alternatively be employed.

The overall length of the example collet insert 104 may be approximately 19.1 mm, with the length of the sleeve portion 116 being approximately 12 mm. In the example of FIGS. 2-5, the flute 132 and the depth of the first slot 138 are approximately 14.6 mm. The shoulder 118 of the flute 132 is formed from three portions 142-146 and is located approximately 12 mm from the end of the sleeve portion 116. In the illustrated example, an angle formed between the first portion 142 and a longitudinal axis 148 is approximately 30°, the second portion 144 is approximately parallel to the longitudinal axis 148 and an angle formed between the third portion 146 and the longitudinal axis 148 is roughly 140. The radius of the bend between the sleeve portion 116 and the first portion 142 is, in this example, approximately 0.6 mm and the radius of the bend between the first portion 142 and the second portion 144 is, in this example, approximately 1.2 mm.

In the example of FIG. 3, the outer periphery of the shoulder portion 118 of the flute 132 curves inwardly at its periphery with a radius of 2.2 mm. The overall diameter of the illustrated sleeve portion 116 is on the order of 4.29 mm. The overall diameter of the shoulder portion 118 is, in this example, roughly 6 mm and the diameter of the opening defined by the gripping portion is roughly 3.2 mm. The edges defining the flutes 132-136 and the gap 130 are chamfered, in the illustrated device, at about 0.3 mm.

The gripping portion 120 of the flute 132 includes a flat portion 150 that contacts the member 108 when the member 108 is fitted into the collet insert 104. As will be readily appreciated, when the member 108 is inserted into the spring collet 104 and the collet nut 106 is tightened to the spindle 102, there exists a first unfilled volume 152 defined by the first, second and third portions 142-146 of the flute 132. Similarly, there is a second unfilled volume 154 defined by the shoulder portion 118 of the second flute 134. There is also a third unfilled volume not shown in the drawings, but that is defined by shoulder portion 118 of the flute 136. These unfilled volumes, 152, 154 and the unfilled volume not shown in the drawings, are formed because the collet insert 104 is fabricated, as described in further detail in connection with FIG. 5, from flat sheet metal, such as, for example, C1095 annealed spring steel that is 0.22 inches thick, that is stamped to form the collet insert 104. Once formed, the collet insert 104 may be austempered to HRC 52-55.

Turning now to FIG. 5, a strip 200, which may be a sheet metal strip, includes representations 202-228 of a collet insert as it is stamped by a progressive die. The nature of the progressive die is that the strip 200 is moved from left to right after each stamping cycle. Accordingly, the results of each stamping operation are shown in the representations 202-228 as progressing from right to left. The following describes each representation 202-228 in sequence and thereby describes one example stamping process used to produce spring collets. As the stamping operations of the progressive die are explained, reference will be made to the features of the collet insert 104 as the features are formed by the progressive die.

At a first stamping operation (202), an aperture 230 is punched in the strip 200. The aperture 230 serves as a reference point that is used to ensure that the strip 200 is properly registered within the progressive die as the strip proceeds therethrough.

At a second stamping operation (204), the progressive die punches out the first and second slots 138 and 140. At the third, fourth and fifth stamping operations (206, 208 and 210), portions of the strip 200 designated with reference numerals 232 and 234 are punched out, or gutted. Gutting refers to removing portions of the strip 200 that are not necessary for the fabrication of the collet insert 104. Once the first and second slots 138 and 140 are made and the portions 232 and 234 have been gutted, material that will be formed into the first, second and third flutes 132-136 remains and is in a flattened state. The portions of material that will be formed into the first, second and third flutes are referred to herein as the first, second and third fingers 236, 238 and 240. The fingers 236-240 are connected by a linking portion 242.

At the sixth stamping operation (212), the edges of the remaining material 244 that will be formed into the flutes 132-136 is coined to remove burs resulting from the punching process. As will be readily appreciated by those having ordinary skill in the art, coining may be carried out using a chamfer or any other suitably shaped die portion. The periphery of the collet insert 104 is coined in the progressive die to prevent interference between the inside and outside diameters of the collet insert 104 due to metal stamping burrs.

At the seventh and eighth stamping operations (FIG. 5B, 214 and 216), the shoulder 118 and the gripping portion 120 of each of the first, second and third flutes 132-136 are formed. A profile of the flutes 132-136 after operation 216 is shown at reference numeral 246.

After the shoulders 118 and the gripping portions 120 are formed, material is progressively shaped into cylindrical form at the ninth—twelfth stamping operations (218-224). In this example, the formation is carried out by progressively bending the material at 60° and at 30° until the material is fashioned into a substantially cylindrical shape.

At a thirteenth stamping operation (226), cam sizing is performed. During the cam sizing operation, a mandrill precisely sized to the desired inner diameter of the collet insert 104 is fitted into the collet insert 104 and the outside of the collet insert is compressed around the mandrill. This step may be referred to as a calibration step at which the inside and outside diameters of the collet insert 104 are stamped to be the proper size. After the thirteenth stamping operation (226), the spring collet 104 is detached from the strip 200 at a fourteenth stamping operation (228).

At the completion of the fourteenth stamping operation (228), no further metal working operation is required. The spring attributes of the collet insert 104 are derived from austempering the collet insert 104 at Rockwell Hardness Scale C (HRC) 52-55. Distortion and movement of the collet insert 104 shape between the metal stamping and heat treat operation are statistically predictable and, therefore, may be compensated for in the stamping process. Subsequent to the austempering process, metal finishing operations such as, for example, anodizing may be performed to enhance the appearance of the spring collet 104.

Although certain apparatus constructed in accordance with the teachings of the invention have been described herein and certain methods have been disclosed, the scope of coverage of this patent is not limited thereto. On the contrary, this patent covers all embodiments of the teachings of the invention fairly falling within the scope of the appended claims either literally or under the doctrine of equivalents.

What is claimed is:

1. A collet insert, comprising:
a substantially cylindrical sleeve;
a shoulder adjacent the sleeve; and
a gripping portion adjacent the shoulder, wherein the sleeve, the shoulder and the gripping portion comprise a longitudinal seam.

2. A collet insert as defined in claim 1, wherein the longitudinal seam comprises an open seam.

3. A collet insert as defined in claim 1, wherein the longitudinal seam is a closed seam in the sleeve.

4. A collet insert as defined in claim 3, wherein interleaved portions of the sleeve define a portion of the seam.

5. A collet insert as defined in claim 1, wherein the sleeve, the shoulder and the gripping portion comprise steel.

6. A collet insert as defined in claim 1, wherein the sleeve, the shoulder and the gripping portion comprise austempered spring steel.

7. A collet insert as defined in claim 1, wherein edges of the sleeve, the shoulder and the gripping portion are coined.

8. A collet insert, comprising:
a substantially cylindrical sleeve having an inner diameter and an outer diameter;
a shoulder adjacent the sleeve and having a larger inner diameter and a larger outer diameter than the sleeve; and
a gripping portion adjacent the shoulder, wherein the gripping portion comprises an inner diameter smaller than the inner diameter of the shoulder.

9. A collet insert as defined in claim 8, wherein an unfilled volume is formed between the shoulder and a cylindrical member when the cylindrical member is inserted into the spring collet.

10. A collet insert as defined in claim 8, wherein the sleeve, the shoulder and the gripping portion comprise steel.

11. A collet insert as defined in claim 8, wherein the sleeve, the shoulder and the gripping portion comprise austempered spring steel.

12. A collet insert as defined in claim 8, wherein edges of the sleeve, the shoulder and the gripping portion are coined.

13. For use with a member, a hand tool comprising:
a spindle having a bore, a tapered inner portion surrounding the bore and a threaded outer periphery;
a collet insert comprising a sleeve sized to be inserted into the bore of the spindle and a shoulder sized to abut the tapered inner portion of the spindle, the collet insert further comprising a gripping portion adjacent the shoulder, wherein the sleeve, the shoulder and the gripping portion comprise a longitudinal seam; and
a collet nut comprising a threaded inner periphery and an aperture, wherein the collet nut is dimensioned to be threaded onto the threaded outer periphery of the spindle and the collet nut and the collet insert are adapted to receive the member that extends into the gripping portion of the collet insert and wherein tightening of the collet nut causes the gripping portion to engage the member.

14. A hand tool as defined in claim 13, wherein the longitudinal seam is an open seam.

15. A hand tool as defined in claim 13, wherein the longitudinal seam is a closed seam in the sleeve.

16. A hand tool as defined in claim 13, wherein interleaved portions of the sleeve define a portion of the seam.

17. A tool comprising:
a spindle having a bore, a tapered inner portion surrounding the bore and a threaded outer periphery;
a collet inset comprising:
a substantially cylindrical sleeve having an inner diameter and an outer diameter, wherein the sleeve is dimensioned to extend into the bore of the spindle;
a shoulder adjacent the sleeve and having a larger inner diameter and a larger outer diameter than the sleeve, wherein the shoulder is located to engage the tapered inner portion of the spindle; and
a gripping portion adjacent the shoulder, wherein the gripping portion comprises an inner diameter smaller than the inner diameter of the shoulder; and
a collet nut comprising a threaded inner periphery and an aperture, wherein the collet nut is sized to be threaded onto the threaded outer periphery of the spindle.

18. A tool as defined in claim 17, wherein an unfilled volume is formed between the shoulder and a cylindrical member when the cylindrical member is inserted into the spring collet.

19. A tool as defined in claim 17, wherein the sleeve, the shoulder and the gripping portion comprise steel.

20. A tool as defined in claim 17, wherein the sleeve, the shoulder and the gripping portion comprise austempered spring steel.

21. A tool as defined in claim 17, wherein edges of the sleeve, the shoulder and the gripping portion are coined.
Process claims

22. A method of fabricating a collet insert from sheet metal, the method comprising:
removing a portion of the sheet metal to form fingers that are each connected to a linking portion;
forming the linking portion into a substantially cylindrical sleeve; and
forming the fingers of planar sheet metal into a shoulder adjacent the sleeve and a gripping portion adjacent the shoulder.

23. A method as defined in claim 22, further comprising coining edges of the fingers.

24. A method as defined in claim 22, further comprising calibrating inner diameters of the sleeve, the shoulder and the gripping portion.

25. A method as defined in claim 24, further comprising calibrating outer diameters of the sleeve, the shoulder and the gripping portion.

26. A method as defined in claim 22, further comprising detaching the shoulder from the sheet metal stock.

27. A method of fabricating a collet insert from substantially planar sheet metal stock, the method comprising:
removing a portion of the sheet metal to form fingers of planar sheet metal that are each connected to a linking portion of planar sheet metal;
forming the linking portion of the planar sheet metal into a substantially cylindrical sleeve having an inner diameter and an outer diameter;
forming the fingers of planar sheet metal into a shoulder adjacent the sleeve, the shoulder having a larger inner diameter and a larger outer diameter than the sleeve; and
forming a gripping portion adjacent the shoulder, wherein the gripping portion comprises an inner diameter smaller than the inner diameter of the shoulder.

28. A method as defined in claim 27, further comprising coining edges of the fingers of planar sheet metal.

29. A method as defined in claim 27, further comprising calibrating inner diameters of the sleeve, the shoulder and the gripping portion.

30. A method as defined in claim 29, further comprising calibrating outer diameters of the sleeve, the shoulder and the gripping portion.

31. A method as defined in claim 27, further comprising detaching the shoulder from the sheet metal stock.

32. A method of fabricating a collet insert from sheet metal, the method comprising:
punching first and second slots in the sheet metal;
removing a portion of the sheet metal to form fingers having a first end connected to a linking portion, the fingers being separate at a second end;
bending the fingers to have arcuate cross sections along a longitudinal axis;
bending the fingers to have angled portions;
forming the linking of the sheet metal into a substantially cylindrical sleeve; and
forming the fingers into a substantially cylindrical shape, wherein the angled portions form a shoulder and the second ends of the fingers form a gripping portion.

33. A method as defined in claim 32, further comprising coining edges of the fingers.

34. A method as defined in claim 32, further comprising calibrating inner diameters of the sleeve, the shoulder and the gripping portion.

35. A method as defined in claim 34, further comprising calibrating outer diameters of the sleeve, the shoulder and the gripping portion.

36. A method as defined in claim 32, further comprising detaching the shoulder from the sheet metal.
